(19) United States
(12) Patent Application Publication
(10) Pub. No.: US 2023/0028348 A1
(43) Pub. Date: Jan. 26, 2023

(54) TERMINAL AND MEASURING METHOD

(71) Applicant: NTT DOCOMO, INC., Tokyo (JP)

(72) Inventor: Yuichi Kakishima, Chiyoda-ku, Tokyo (JP)

(73) Assignee: NTT DOCOMO, INC., Tokyo (JP)

(21) Appl. No.: 17/785,316

(22) PCT Filed: Dec. 20, 2019
(86) PCT No.: PCT/JP2019/050207

§ 371 Date: Jun. 14, 2022

(51) Int. Cl. H04B 17/336; H04W 72/02

(52) U.S. Cl. CPC H04B 17/336; H04W 72/02

(57) ABSTRACT

A terminal includes a control unit that determines a resource to be used for measurement, based on a condition, among a plurality of resources for estimating interference, and a measuring unit that measures L1-SINR (Layer1 Signal to interference plus noise power ratio) using the determined resource.

### TECHNICAL FIELD

The present invention relates to a terminal and a measuring method in a radio communication system.

### BACKGROUND ART

In NR (New Radio) (also referred to as 5G) being the succeeding system of the LTE (Long Term Evolution), a technology of satisfying, as requirements, a large-capacity system, a high-speed data transmission rate, a low delay, a simultaneous connection of multiple terminals, low cost, power saving, and the like is discussed (for example, Non-Patent Document 1).

In NR release 16, function expansion related to beam management is discussed. Measurement of L1-SINR (Layer1 Signal to interference plus noise power ratio) is expected to be introduced as one of the functions related to the beam management. As measurement of Layer 1, measurement of L1-RSRP (Layer 1 Reference signal received power) has been introduced in NR Release 15 (for example, Non-Patent Document 2).

### CITATION LIST

### Non-Patent Document

Non-Patent Document 1: 3GPP TS 38.300 V15.7.0 (2019-09)
Non-Patent Document 2: 3GPP TS 38.133 V15.7.0 (2019-09)

### SUMMARY OF THE INVENTION

### Problem to be Solved by the Invention

In the measurement of L1-SINR, an IMR (Interference measurement resource) being an interference estimation resource can be used in addition to a CMR (Channel measurement resource) being a channel estimation resource used in measurement of L1-RSRP. A plurality of IMRs may be configured.

A case is assumed in which one of IMRs is dominant depending on a communication environment in a case where the plurality of IMRs are configured for the measurement of L1-SINR.

The invention has been made in view of the above points, and an object thereof is to simplify measurement by determining a resource to be used for the measurement from among candidates in a radio communication system.

### Means for Solving Problem

According to a technology of the disclosure, there is provided a terminal including a control unit that determines a resource to be used for measurement, based on a condition, among a plurality of resources for estimating interference, and a measuring unit that measures L1-SINR (Layer1 Signal to interference plus noise power ratio) using the determined resource.

### Effect of the Invention

According to the technology of the disclosure, in a radio communication system, it is possible to simplify measurement by determining a resource to be used for the measurement from among candidates.

### BRIEF DESCRIPTION OF DRAWINGS

FIG. 1 is a diagram illustrating a configuration example of a radio communication system according to an embodiment of the invention;

FIG. 2 is a diagram illustrating Measurement Example (1) in the embodiment of the invention;

FIG. 3 is a diagram illustrating Measurement Example (2) in the embodiment of the invention;

FIG. 4 is a diagram illustrating Measurement Example (3) in the embodiment of the invention;

FIG. 5 is a diagram illustrating Measurement Example (4) in the embodiment of the invention;

FIG. 6 is a flowchart for describing Measurement Example (1) in the embodiment of the invention;

FIG. 7 is a flowchart for describing Measurement Example (2) in the embodiment of the invention;

FIG. 8 is a flowchart for describing Measurement Example (3) in the embodiment of the invention;

FIG. 9 is a diagram illustrating an example of a functional configuration of a base station 10 in the embodiment of the invention;

FIG. 10 is a diagram illustrating an example of a functional configuration of a terminal 20 in the embodiment of the invention; and

FIG. 11 is a diagram illustrating an example of a hardware configuration of the base station 10 or the terminal 20 in the embodiment of the invention.

### MODE(S) FOR CARRYING OUT THE INVENTION

Hereinafter, an embodiment of the invention will be described with reference to the drawings. Note that the embodiment described below is just an example, and the embodiment to which the invention is applied is not limited to the following embodiment.

The known technology is appropriately used in an operation of a radio communication system in the embodiment of the invention. At this time, the known technology is, for example, known LTE, but is not limited to the known LTE. In addition, unless otherwise specified, it is assumed that the term “LTE” used in this specification has a broad meaning including LTE-Advanced and the subsequent schemes (for example, NR) of LTE-Advanced.

In addition, in the embodiment of the invention, which will be described below, terms of an SS (Synchronization signal), a PSS (Primary SS), an SSS (Secondary SS), a PBCH (Physical broadcast channel), a PRACH (Physical random access channel), a PDCCH (Physical Downlink Control Channel), a PDSCH (Physical Downlink Shared Channel), a PUCCH (Physical Uplink Control Channel), a PUSCH (Physical Uplink Shared Channel), and the like, which are used in the known LTE, are used. This is for convenience of description, and signals, functions, and the like similar to the above description may be referred to by other names. In addition, the above-described terms in NR correspond to an NR-SS, an NR-PSS, an NR-SSS, an NR-PBCH, an NR-PRACH, and the like. However, it is not necessary to specify a signal used in NR as “NR—”.

In addition, in the embodiment of the invention, a duplex scheme may be a TDD (Time Division Duplex) scheme or a FDD (Frequency Division Duplex), or may be a scheme (for example, Flexible Duplex) other than the TDD scheme and the FDD scheme.

In addition, in the embodiment of the invention, “configuring” of a radio parameter and the like may mean that a predetermined value is pre-configured or that a radio parameter that is indicated by a base station 10 or a terminal 20, is configured.

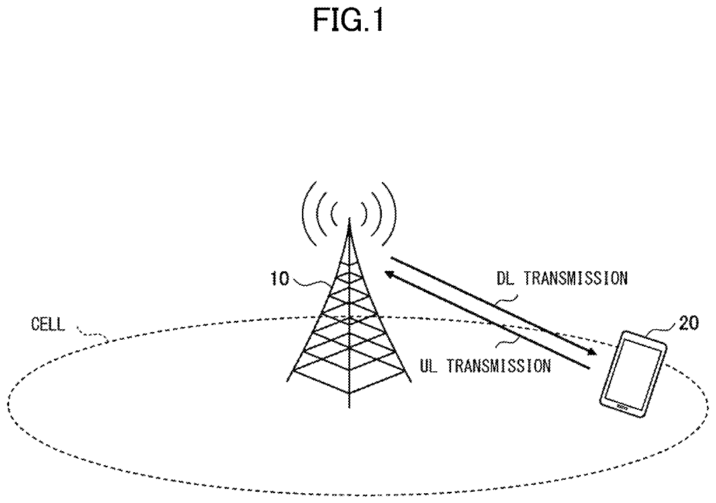

FIG. 1 is a diagram illustrating a configuration example of a radio communication system in the embodiment of the invention. In the embodiment of the invention, the radio communication system includes a base station 10 and a terminal 20, as illustrated in FIG. 1. Although FIG. 1 illustrates one base station 10 and one terminal 20, FIG. 1 is just an example. A plurality of base stations and a plurality of terminals may be provided.

The base station 10 is a communication device that provides one or more cells and performs a radio communication with the terminal 20. The physical resource of a radio signal may be defined in a time domain and a frequency domain. The time domain may be defined by the number of OFDM (Orthogonal Frequency Division Multiplexing) symbols. The frequency domain may be defined by the number of subcarriers or the number of resource blocks. The base station 10 transmits a synchronization signal and system information to the terminal 20. The synchronization signal includes, for example, an NR-PSS and an NR-SSS. The system information is also referred to as broadcast information which is transmitted on an NR-PBCH, for example. The synchronization signal and the system information may be referred to as an SSB (SS/PBCH block). As illustrated in FIG. 1, the base station 10 transmits a control signal or data to the terminal 20 by a DL (Downlink) and receives a control signal or data from the terminal 20 by an UL (Uplink). Both the base station 10 and the terminal 20 may perform beam forming and perform transmission and reception of a signal. In addition, both the base station 10 and the terminal 20 may apply a communication by MIMO (Multiple Input Multiple Output) to the DL or the UL. In addition, both the base station 10 and the terminal 20 may perform a communication through a secondary cell (SCell) and a primary cell (PCell) by CA (Carrier Aggregation). Furthermore, the terminal 20 may perform a communication through a primary cell of the base station 10 and a primary secondary cell (PSCell) of another base station 10 by DC (Dual Connectivity).

The terminal 20 is a communication device including a radio communication function, such as a smart phone, a portable phone, a tablet, a wearable terminal, or a communication module for M2M (Machine-to-Machine). As illustrated in FIG. 1, the terminal 20 receives a control signal or data from the base station 10 by the DL and transmits a control signal or data to the base station 10 by the UL, and the terminal uses various communication services by the radio communication system in this manner.

Here, in NR release 16, function expansion related to beam management is discussed. Measurement of L1-SINR (Layer1 Signal to interference plus noise power ratio) is expected to be introduced as one of the functions related to the beam management. As measurement of Layer 1, measurement of L1-RSRP (Layer 1 Reference signal received power) has been introduced in NR Release 15.

In the measurement of L1-SINR, an IMR (Interference measurement resource) being an interference estimation resource can be used in addition to a CMR (Channel measurement resource) being a channel estimation resource used in measurement of L1-RSRP. Meanwhile, regarding the measurement period of L1-SINR, it is necessary to consider the periods of the CMR and the IMR in order to ensure measurement accuracy. Thus, preferably, the measurement period of L1-SINR is defined separately from the measurement period of L1-RSRP. Thus, an operation related to the measurement of L1-SINR is defined separately from that for L1-RSRP.

In the measurement of L1-SINR, the base station 10 may perform resource configuration and reporting configuration by RRC (Radio Resource Control) signaling, to the terminal 20 as in 1) 2) as follows.

1) The SSB and CSI-RS (Channel State Information-Reference Signal) resources may be configured. The SSB and the CSI-RS used in L1-SINR reporting may be specified by RRC signaling. Information elements of the RRC signaling may include L1SINR-ResourceConfig, for example. The terminal 20 may measure the value of L1-SINR for each reference signal configured by the RRC signaling. Each of the reference signals may correspond to a corresponding beam to be transmitted by the base station 10. In the case of the CSI-RS, a periodic CSI-RS, a semi-persistent CSI-RS, and an aperiodic CSI-RS may be configured as the CSI-RS configuration. The semi-persistent CSI-RS or the aperiodic CSI-RS may be activated or triggered by a MAC-CE (Media Access Control-Control Element) or by DCI (Downlink Control Information).

2) Reporting may be configured. The type of L1-SINR reporting, the number of reference signals to be reported, and the like may be specified by RRC signaling.

Information elements of the RRC signaling may include L1SINR-ReportConfig, for example. As the type of reporting, periodic reporting, semi-persistent reporting, and aperiodic reporting may be configured. The periodic reporting, the semi-persistent reporting, and the aperiodic reporting may be activated or triggered by the MAC-CE or by the DCI.

Table 1 shows the CSI-RS configuration which may be performed for each type of CSI reporting. As in 2), each type of CSI reporting may be applied to L1-SINR reporting which is similarly measured using the CSI-RS.

TABLE 1

| CSI-RS | Periodic CSI | Semi-Persistent CSI | |
|---|---|---|---|
| Configurati on | Reporting | Reporting | Aperiodic CSI Reporting |
| Periodic | No dynamic | For reporting on PUCCH, the UE | Triggered by DCI; |
| CSI-RS | triggering/activation | receives an activation | additionally, activation |
| | | command [10, TS 38.321]; for | command [10, TS 38.321] |
| | | reporting on PUSCH, the UE | possible as defined in |
| | | receives triggering on DCI | Subclause 5.2.1.5.1. |
| Semi- | Not Supported | For reporting on PUCCH, the UE | Triggered by DCI; |
| Persistent | | receives an activation | additionally, activation |
| CSI-RS | | command [10, TS 38.321]; for | command [10, TS 38.321] |
| | | reporting on PUSCH, the UE | possible as defined in |
| | | receives triggering on DCI | Subclause 5.2.1.5.1. |
| Aperiodic | Not Supported | Not Supported | Triggered by DCI; |
| CSI-RS | | | additionally, activation |
| | | | command [10, TS 38.321] |
| | | | possible as defined in |
| | | | Subclause 5.2.1.5.1. |

As shown in Table 1, in the periodic CSI reporting, the periodic CSI-RS does not support dynamic triggering or activation. The periodic CSI reporting does not support the semi-persistent CSI-RS and the aperiodic CSI-RS. In addition, as shown in Table 1, in the semi-persistent CSI reporting, the periodic CSI-RS and the semi-persistent CSI-RS are triggered by the DCI and are reported on a PUSCH. The semi-persistent CSI reporting does not support the aperiodic CSI-RS. In the aperiodic CSI reporting, the periodic CSI-RS, the semi-persistent CSI-RS, and the aperiodic CSI-RS are triggered by the DCI and reported on a PUSCH.

Regarding the measurement period of L1-SINR, the number of latest samples within which L1-SINR measurement is required to be completed, may be defined for each reporting. For example, when the number of samples used for measurement of the L1-SINR reporting is set as “M”, a scaling factor considering overlap with an SMTC (SS block based RRM measurement timing configuration) or an MG (Measurement gap) is set as “P”, and a scaling factor considering reception beam switching of the terminal 20 is set as “N”, the measurement period of L1-SINR may be defined as M×P×(SSB or CSI-RS period) in FR1 (Frequency Range 1), and may be defined as M×N×P×(SSB or CSI-RS period) in FR2.

Table 2 shows an example of configuring the number M of samples.

TABLE 2

| Condition | Number of samples |
|---|---|
| In case where | M = 1 |
| timeRestrictionForChannelMeasurement is | |
| configured, or in case of aperiodic CSI-RS | |
| Others | M = 3 |
| | ※ Whether or not to |
| | apply averaging by three |
| | samples is up to UE |

As shown in Table 2, in a case where an information element timeRestrictionForChannelMeasurement is configured or in the case of the aperiodic CSI-RS, M may be set to 1. In other cases, M may be set to 3 and may depend on the implementation of the terminal 20.

Table 3 shows an example of configuring the scaling factor N.

TABLE 3

| | Scaling factor considering |
|---|---|
| Condition | UE reception beam switching |
| CSI-RS based reporting | N = 1 |
| SSB based reporting | N = 8 |
| CSI-RS with repetition ON, and | ceil(maxNumberRxBeam/number |
| number of CSI-RS resources < | of CSI-RS resources) |
| maxNumberRxBeam | |

As shown in Table 3, in the case of CSI-RS based reporting, N may be set to 1. In addition, in the case of SSB based reporting, N may be set to 8. In addition, in a case where repetition of the CSI-RS is enabled, and the number of CSI-RS resources is less than the number of reception beams supported by the terminal 20, N may be set to ceil (number of reception beams/number of CSI-RS resources).

The measurement period of L1-SINR using the SSB in FR1 may be defined in accordance with the state of DRX (Discontinuous reception), as shown in Table 4. Note that T_{SSB} indicates a periodicity of the SSB, which is configured for L1-SINR measurement and is associated with a certain SSB index. T_{DRX} indicates the length of a DRX cycle. T_{Report} indicates a periodicity configured for reporting.

TABLE 4

| Configuration | T_{L1-SINR}_Measurement_Period_SSB (ms) |
|---|---|
| non-DRX | max (T_{Report}, ceil (M * P) * T_{SSB}) |
| DRX cycle ≤ 320 ms | max (T_{Report}, ceil (1.5 * M * P) * max (T_{DRX}, T_{SSB})) |
| DRX cycle > 320 ms | ceil (M * P) * T_{DRX} |

Note:
T_{SSB} = ssb-periodicityServingCell is the periodicity of the SSB-Index configured for L1-SINR measurement. T_{DRX} is the DRX cycle length. T_{Report} is configured periodicity for reporting.

As shown in Table 4, in the case of the non-DRX state, the measurement period T_{L1-SINR_Measurement_Period_SSB} of L1-SINR may be set to max (T_{Report}, ceil (M*P)*T_{SSB}). In a case where the DRX cycle is equal to or shorter than 320 ms, T_{L1-SINR_Measurement_Period_SSB} may be set to max (T_{Report}, ceil (1.5*M*P)*max (T_{DRX}, T_{SSB})). In a case where the DRX cycle is longer than 320 ms, T_{L1-SINR_Measurement_Period_SSB} may be set to ceil (M*P)*T_{DRX}.

The measurement period of L1-SINR using the CSI-RS in FR1 may be defined in accordance with the state of the DRX as shown in Table 5. Note that T_{CSI-RS} indicates the periodicity of CSI-RS configured for L1-SINR measurement. T_{DRX} indicates the length of the DRX cycle. T_{Report} indicates the configured periodicity for reporting. In addition, for example, the configuration related to the measurement period shown in Table 5 may be applied to a case where the density of CSI-RS resources configured for L1-SINR measurement is 3.

TABLE 5

| Configuration | T_{L1-SINR}_Measurement_Period_SSB (ms) |
|---|---|
| non-DRX | max (T_{Report}, ceil (M * P) * T_{CSI-RS}) |
| DRX cycle ≤ 320 ms | max (T_{Report}, ceil (1.5 * M * P) * max (T_{DRX}, T_{CSI-RS})) |
| DRX cycle > 320 ms | ceil (M * P) * T_{DRX} |

Note 1:
T_{CSI-RS} is the periodicity of CSI-RS configured for L1-SINR measurement. T_{DRX} is the DRX cycle length. T_{Report} is configured periodicity for reporting.
Note 2:
the requirements are applicable provided that the CSI-RS resource configured for L1-SINR measurement is transmitted with Density = 3.

As shown in Table 5, in the case of the non-DRX state, the measurement period T_{L1-SINR_Measurement_Period_CSI-RS} of L1-SINR may be set to max (T_{Report}, ceil (M*P)*T_{CSI-RS}). In a case where the DRX cycle is equal to or shorter than 320 ms, T_{L1-SINR_Measurement_Period_CSI-RS} may be set to max (T_{Report}, ceil (1.5*M*P)*max (T_{DRX}, T_{CSI-RS})). In a case where the DRX cycle is longer than 320 ms, T_{L1-SINR_Measurement_Period_CSI-RS} may be set to ceil (M*P)*T_{DRX}.

The measurement period of L1-SINR using the SSB in FR2 may be defined in accordance with the state of the DRX as shown in Table 6. Note that T_{SSB} indicates the periodicity of the SSB, which is configured for L1-SINR measurement and is associated with a certain SSB index. T_{DRX} indicates the length of a DRX cycle. T_{Report} indicates the configured periodicity for reporting.

TABLE 6

| Configuration | T_{L1-SINR}_Measurement_Period_SSB (ms) |
|---|---|
| non-DRX | max (T_{Report}, ceil (M * P * N) * T_{SSB}) |
| DRX cycle ≤ 320 ms | max (T_{Report}, ceil (1.5 * M * P * N) * max (T_{DRX}, T_{SSB})) |
| DRX cycle > 320 ms | ceil (1.5 * M * P * N) * T_{DRX} |

Note: T_{SSB} = ssb-periodicityServingCell is the periodicity of the SSB-Index configured for L1-SINR measurement. T_{DRX} is the DRX cycle length. T_{Report} is configured periodicity for reporting.

As shown in Table 6, in the case of the non-DRX state, the measurement period T_{L1-SINR_Measurement_Period_SSB} of L1-SINR may be set to max (T_{Report}, ceil (M*P*N)*T_{SSB}). In a case where the DRX cycle is equal to or shorter than 320 ms, T_{L1-SINR_Measurement_Period_SSB} may be set to max (T_{Report}, ceil (1.5*M*P*N)*max (T_{DRX}, T_{SSB})). In a case where the DRX cycle is longer than 320 ms, T_{L1-SINR_Measurement_Period_SSB} may be set to ceil (1.5M*P*N)*T_{DRX}.

The measurement period of L1-SINR using the CSI-RS in FR2 may be defined in accordance with the state of the DRX as shown in Table 7. Note that T_{CSI-RS} indicates the periodicity of CSI-RS configured for L1-SINR measurement. T_{DRX} indicates the length of a DRX cycle. T_{Report} indicates the configured periodicity for reporting. In addition, for example, the configuration related to the measurement period shown in Table 7 may be applied to a case where the density of CSI-RS resources configured for L1-SINR measurement is 3.

TABLE 7

| Configuration | T_{L1-SINR}_Measurement_Period_SSB (ms) |
|---|---|
| non-DRX | max (T_{Report}, ceil (M * P * N) * T_{CSI-RS}) |
| DRX cycle ≤ 320 ms | max (T_{Report}, ceil (1.5 * M * P * N) * max (T_{DRX}, T_{CSI-RS})) |
| DRX cycle > 320 ms | ceil (M * P * N) *T_{DRX} |

Note 1:
T_{CSI-RS} is the periodicity of CSI-RS configured for L1-SINR measurement. T_{DRX} is the DRX cycle length. TReport is configured periodicity for reporting.
Note 2:
the requirements are applicable provided that the CSI-RS resource configured for L1-SINR measurement is transmitted with Density = 3.

As shown in Table 7, in the case of the non-DRX state, the measurement period T_{L1-SINR_Measurement_Period_CSI-RS} of L1-SINR may be set to max (T_{Report}, ceil (M*P*N)*T_{CSI-RS}). In a case where the DRX cycle is equal to or shorter than 320 ms, T_{L1-SINR_Measurement_Period_CSI-RS} may be set to max (T_{Report}, ceil (1.5*M*P*N)*max (T_{DRX}, T_{CSI-RS})). In a case where the DRX cycle is longer than 320 ms, T_{L1-SINR_Measurement_Period_CSI-RS} may be set to ceil (M*P*N)*T_{DRX}.

In addition, the measurement accuracy of L1-SINR may be defined. Whether or not to apply L1 averaging may be dependent on the implementation of the terminal 20. In a case where an information element timeRestrictionForChannelMeasurements is configured, the terminal 20 may perform reporting of a measurement result with one sample without averaging.

Regarding the L1-SINR reporting, the number of reference signals to be reported may be specified by an information element nrofReportedRS. In addition, the number of reference signals to be reported may be equal to or less than N_max. N_max may be set to 2 or 4 in accordance with UE capability.

In the case of nrofReportedRS=1, the terminal 20 may report L1-SINR based on a mapping table showing the association between the measurement result and the report value. In a case where nrofReportedRS is greater than 1 or groupBasedBeamReporting is enabled, the maximum value may be reported based on the mapping table, and other values may be reported as a form of a difference from the maximum value.

The configurable L1-SINR resource may be configured separately from the reference signal to be reported, or may be configured for each terminal 20.

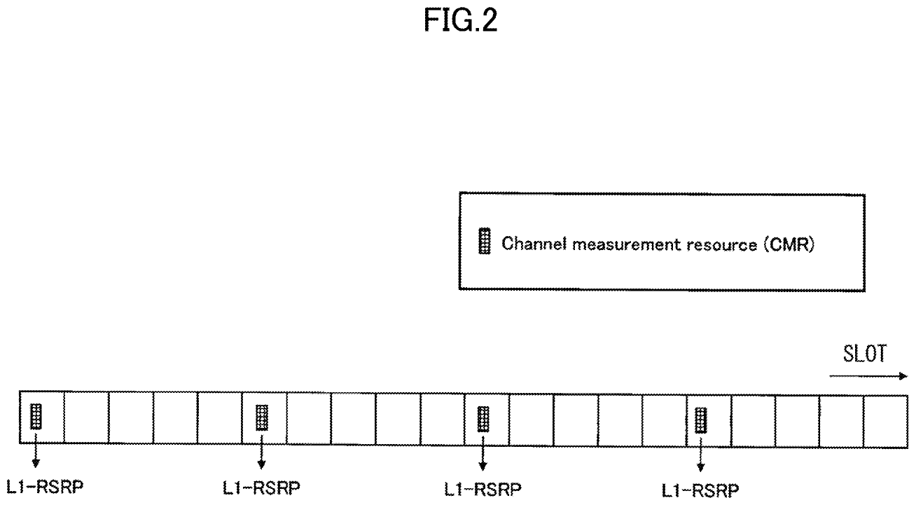

FIG. 2 is a diagram illustrating Measurement Example (1) in the embodiment of the invention. The above-described measuring method for L1-SINR may be similarly applied to measurement of L1-RSRP. FIG. 2 illustrates an example in which L1-RSRP is measured in a unit of five slots. The terminal 20 measures L1-RSRP using the CMR such as the SSB or the CSI-RS.

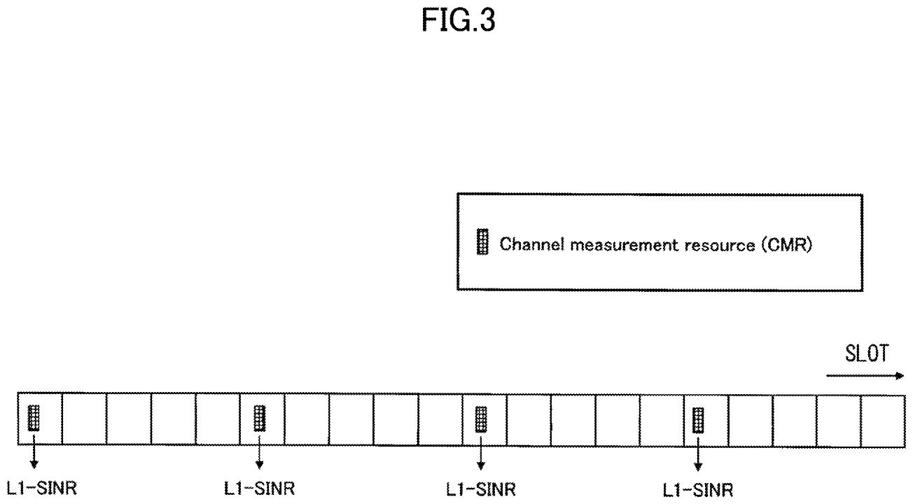

FIG. 3 is a diagram illustrating Measurement Example (2) in the embodiment of the invention. The measurement time for L1-SINR is configured. The terminal 20 needs to complete the measurement within the configured measurement time. L1-SINR may be measured using only the CMR without configuring the IMR, for example. FIG. 3 illustrates an example in which L1-SINR is measured at an interval of five slots, without configuring the IMR. As illustrated in FIG. 3, the L1-SINR measurement may be performed using the CMR which is used for L1-RSRP measurement.

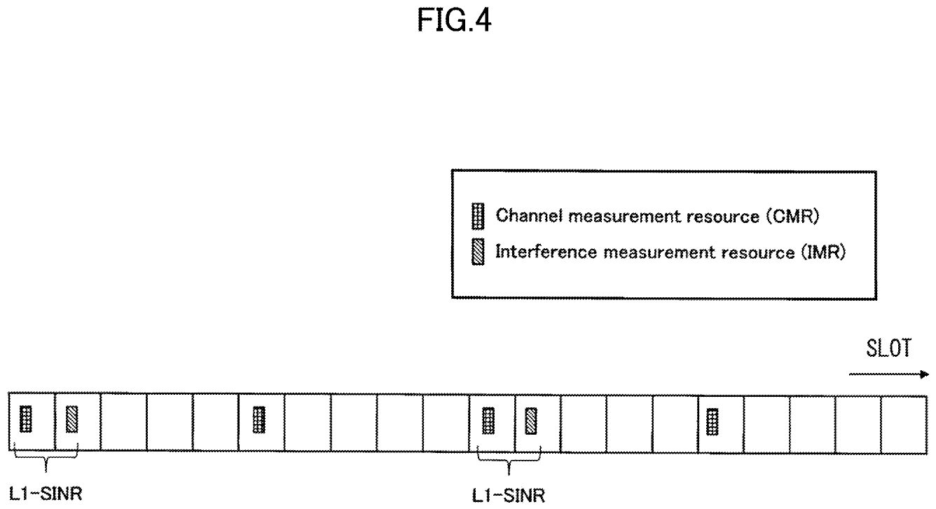

FIG. 4 is a diagram illustrating Measurement Example (3) in the embodiment of the invention. As illustrated in FIG. 4, in the L1-SINR measurement, the IMR for interference estimation may be used in addition to the CMR. FIG. 4 illustrates an example in which L1-SINR is measured with the CMR and the IMR in a unit of ten slots. In addition, either or both an NZP (non-zero power)-CSI-RS and CSI-IM (Interference measurement) may be configured as the IMR. The CMR period may be different from the IMR period. For example, the NZP-CSI-RS may be used for measuring the interference between MIMO users in the own cell. The CSI-IM may be used for measuring the interference from other cells. In addition, the NZP-CSI-RS and the CSI-IM may be configured in the terminal 20 by signaling from the base station 10.

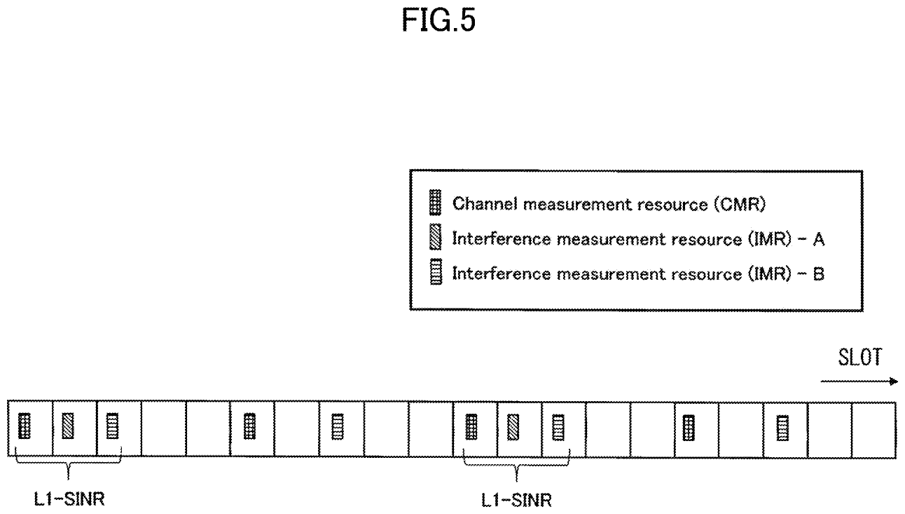

FIG. 5 is a diagram illustrating Measurement Example (4) in the embodiment of the invention. As illustrated in FIG. 5, in the L1-SINR measurement, a plurality of different types of IMRs may be used in addition to the CMR. FIG. 5 illustrates an example in which L1-SINR is measured with the CMR and two types of IMRs at an interval of ten slots. For example, an IMR-A illustrated in FIG. 5 may be the NZP-CSI-RS, and an IMR-B illustrated in FIG. 5 may be the CSI-IM. In addition, for example, the IMR-A illustrated in FIG. 5 may be the CSI-IM, and the IMR-B illustrated in FIG. 5 may be the NZP-CSI-RS.

As described above, in SINR measurement or other CSI measurement, a plurality of interference estimation resources may be configured. For example, there is a case where one of two interference estimation resources is dominant in a case where the two interference estimation resources are provided. For example, in a case where inter-cell interference is measured with a first interference estimation resource, and interference between users is measured with a second interference estimation resource, in an environment in which the inter-cell interference is dominant, it is expected that the measured SINR value does not change largely even though the second interference estimation resource is ignored.

Thus, a technique of simplifying interference estimation and reducing a measurement period (MP), in a case where a plurality of interference estimation resources are configured, is proposed. For example, a method of not using the interference estimation resource having relatively small power, for measurement, may be performed. In addition, for example, a method of performing provisional measurement for determining whether or not the interference estimation resource is used for measurement, may be performed.

In a case where the plurality of interference estimation resources are configured, all of the interference estimation resources may be used for the measurement. In addition, in a case where the plurality of interference estimation resources are configured, some of the interference estimation resources may be used for the measurement. Additionally, the interference estimation resource need not be applied to the measurement result. For example, in a case where interference power measured in the interference estimation resource is very small, the SINR value to be reported may be set to an upper limit value (for example, SINR>=30 dB). The terminal 20 may perform, if necessary, switching between a method of using all interference estimation resources for the measurement, a method of using some interference estimation resources for the measurement, and a method of not using any interference estimation resource, and then perform the method as a result of the switching.

The interference power observed by the terminal 20 may change from moment to moment. Therefore, regarding a technology of limiting the number of interference resources described above, a duration in which the technology is applied may be limited.

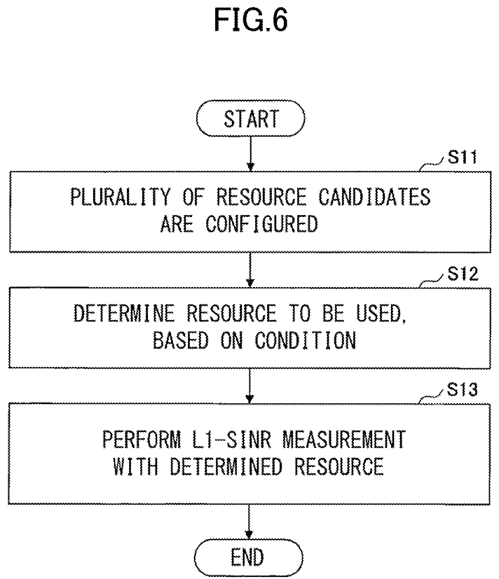

FIG. 6 is a flowchart for describing Measurement Example (1) in the embodiment of the invention. In Step S11, a plurality of resource candidates are configured from the base station 10 to the terminal 20. The resource is a resource for measuring the interference, and may be the IMR or the CMR. Then, the terminal 20 determines the resource to be used for measurement, based on a condition (S12).

For example, the terminal 20 may determine the resource to be used for measurement, based on power set as the condition. For example, the terminal 20 may determine that a resource, in which the maximum interference power has been measured, is to be used. For example, the terminal 20 may determine that a resource, in which the maximum power has been measured, is to be used. For example, the terminal 20 may determine that a resource, whose interference power is less than that of a resource in which the maximum interference power has been measured, by X dB or more, is not to be used. For example, the terminal 20 may determine not to use, for the measurement, a resource in which the absolute value of the measured power is equal to or less than Y dBm. For example, the terminal 20 may determine to use a resource in which the absolute value of the measured power is equal to or greater than Y dBm, for the measurement. The terminal 20 may determine a resource to be used for the measurement based on a combination of the above-described conditions related to the power. For example, the terminal 20 may determine a resource to be used, based on a relative value from signal power (power of the CMR).

In addition, for example, the terminal 20 may determine a resource to be used, based on measurement accuracy as the condition. For example, the terminal 20 may determine not to use, for the measurement, a resource in which the absolute value of the measured power is equal to or less than Y dBm. For example, the terminal 20 may determine to use, for the measurement, a resource in which the SINR, the SNR (Signal-to-Noise Ratio), or the RSRQ (Reference Signal Received Quality) is equal to or greater than a predetermined value. In a case where the resource is the CMR, the SINR, the SNR, or the RSRQ may be measured. In a case where the resource is the IMR, the SINR, the SNR, or the RSRQ may be measured by using interference power as a signal and noise power as noise. The terminal 20 may determine a resource to be used for the measurement based on a combination of the above-described conditions related to the measurement accuracy.

In addition, for example, the terminal 20 may determine a resource to be used, based on the number of resources as the condition. For example, the terminal 20 may determine to use, for the measurement, N resources in order from the largest measurement power. For example, N may be 2, 3, or equal to or greater than 4. For example, the terminal 20 may determine the number of resources which are determined to be used for the measurement, based on the number of configured resource candidates. For example, the terminal 20 may determine to use 50% or more of the configured resource candidates.

In Step S13, the terminal 20 performs L1-SINR measurement with the determined resources.

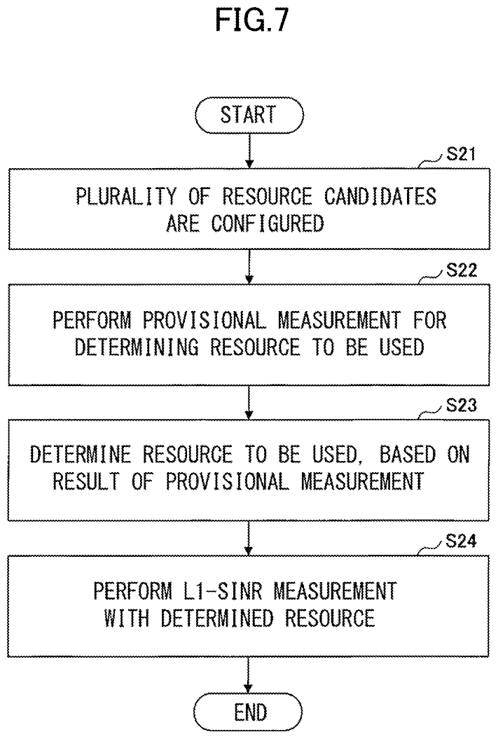

FIG. 7 is a flowchart for describing Measurement Example (2) in the embodiment of the invention. In a case where: the resources to be used for the measurement is determined; or the number of resources to be used for the measurement is determined, based on the condition, as in Step S12 illustrated in FIG. 6, provisional measurement may be performed in order to determine whether or not the condition is satisfied.

In Step S21, a plurality of resource candidates are configured by the base station 10 to the terminal 20. The resource is a resource for measuring the interference, and may be the IMR or the CMR. Then, the terminal 20 performs provisional measurement for determining a resource to be used for the measurement (S22).

For example, the number of samples to be subjected to the provisional measurement may be defined. For example, the terminal 20 may determine whether or not to use a resource for the measurement, based on provisional measurement of N samples in the resource. For example, the terminal 20 may determine whether or not to perform the subsequent measurement, based on provisional measurement of N samples in a certain resource. For example, N may be 1, 2, or equal to or greater than 3.

In addition, for example, the terminal 20 may perform the provisional measurement based on a resource having the shortest measurement section among a plurality of resources. The plurality of resources may be only IMRs or further include the CMR.

In addition, for example, the terminal 20 may also complete the provisional measurement and determine a resource to be used for the measurement, at a time point at which the measurement section in the CMR is ended.

In Step S23, the terminal 20 determines a resource to be used, based on the result of the provisional measurement. Then, the terminal 20 performs L1-SINR measurement with the determined resource (S24).

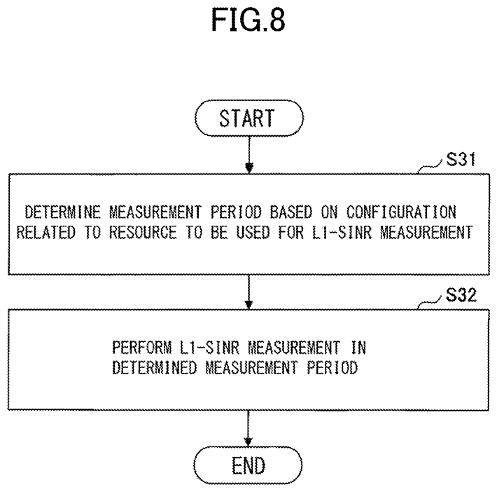

FIG. 8 is a flowchart for describing Measurement Example (3) in the embodiment of the invention. In Step S31, the terminal 20 determines the measurement period (MP) based on the configuration relating to the IMR to be used for L1-SINR measurement. For example, the terminal 20 may determine the measurement period for L1-SINR, based on the multiplexing period of the IMR. In addition, for example, the terminal may determine the measurement period for L1-SINR, based on the IMR having the longest multiplexing period as a reference. In addition, for example, the terminal may determine the measurement period for L1-SINR, based on the IMR having the shortest multiplexing period as a reference. In addition, for example, the terminal may determine the measurement period for L1-SINR, based on the average value of multiplexing periods of a plurality of IMRs, as a reference.

In addition, for example, the terminal may determine the measurement period based on the number of samples obtained by summing up a plurality of types of resources to be used for the measurement. Further, in a case where the terminal determines the measurement period based on the number of samples obtained by summing up the plurality of types of resources to be used for the measurement, the terminal may calculate SINR by using weighted-averaging according to the number of samples for each resource type. For example, a time, in which N samples of IMR1 and IMR2 in total are secured, may be defined as the measurement period. For example, when N is 5, two samples are set for IMR1, and three samples are set for IMR2, SINR may be calculated by multiplying ⅖ by IMR1 and multiplying ⅗ by IMR2. For example, a time, in which one or more samples are secured for IMR1 and one or more samples are secured for IMR2, may be defined as the measurement period.

In Step S32, the terminal 20 performs L1-SINR measurement in the measurement period determined in Step S31.

When a plurality of IMRs are configured, the load of the terminal 20 on the measurement increases. Thus, the measurement period may be changed in accordance with the number of the plurality of IMRs. For example, as the number of IMRs increases, the measurement period may be configured to increase. For example, the change of the measurement period may be defined as the change of the scaling factor. For example, the measurement period may be determined or defined based on the number of CMRs in addition to the number of IMRs. For example, the measurement period may be determined or defined based on the total number of CMRs and IMRs.

In the above-described example, the method of determining the resource for estimating the interference is described. A similar method may also be applied to a method of determining a resource for estimating a channel. For example, in a case where a plurality of channel estimation resources are configured, channel estimation may be performed using some channel estimation resources. In addition, for example, the measurement may be performed without using a channel measurement resource having low measurement quality.

In the above-described example, an indication of signaling from the base station 10 to the terminal 20 or signaling from the terminal 20 to the base station 10 may be performed by an implicit method in addition to an explicit method. Alternatively, signaling need not be performed, and unique definition in the specification may be performed.

In the above-described example, signaling from the base station 10 to the terminal 20 or signaling from the terminal 20 to the base station 10 may be signaling in a different layer, such as RRC signaling, signaling by the MAC-CE, or signaling by the DCI, or may be signaling by broadcast information (MIB (Master Information Block), SIB (System Information Block)). In addition, for example, RRC signaling and signaling by the DCI may be combined. RRC signaling and signaling by the MAC-CE may be combined. RRC signaling, signaling by the MAC-CE, and signaling by the DCI may be combined.

In the above-described example, the technology related to L1-SINR measurement and reporting is disclosed. The measurement and reporting to which this technology can be applied are not limited to L1-SINR. For example, the technology may be applied to measurement and reporting in a higher layer in addition to Layer 1, or may be applied to measurement items (for example, RSRP, RSRQ, or RSSI) other than SINR.

The above-described examples may be combined with each other. The features disclosed in the above-described examples may be combined in various manners. The combination is not limited to the specific combinations disclosed.

With the above-described examples, the terminal 20 can determine the resource required for measuring the interference, from resource candidates based on the configured condition, and thus can measure L1-SINR by using the determined resource with high efficiency. In addition, the terminal 20 can determine the resources required for measuring the interference, from resource candidates, according to the provisional measurement prior to the measurement, and can measure L1-SINR by using the determined resources with high efficiency.

That is, in the radio communication system, it is possible to simplify measurement by determining a resource to be used for the measurement from among candidates.

(Device Configuration)

Next, a functional configuration example of the base station 10 and the terminal 20 that perform the processing and the operations described above will be described. The base station 10 and the terminal 20 include functions of implementing the above-described example. However, each of the base station 10 and the terminal 20 may include only some of the functions in the example.

<Base Station 10>

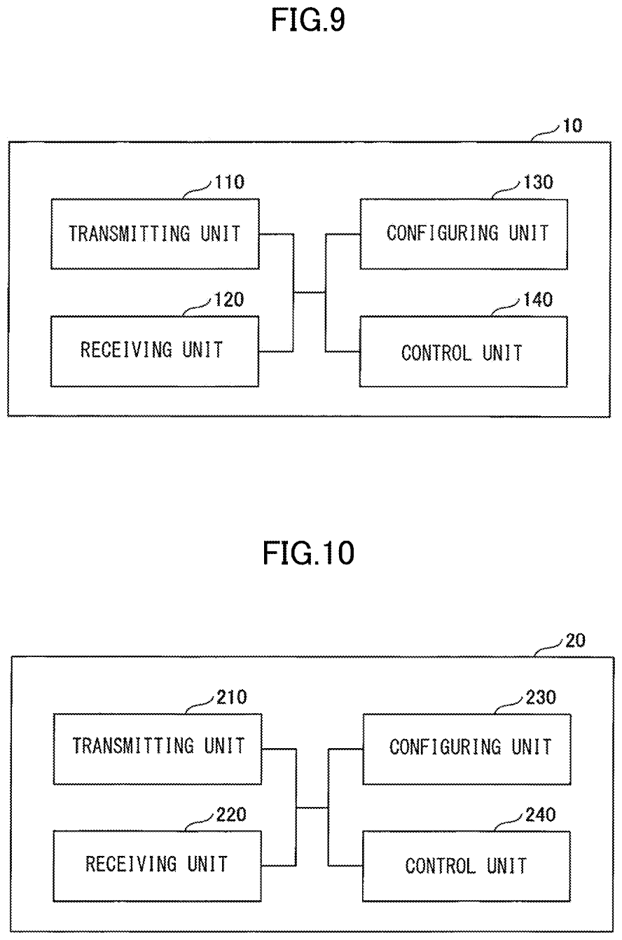

FIG. 9 is a diagram illustrating an example of a functional configuration of the base station 10 in the embodiment of the invention. As illustrated in FIG. 9, the base station 10 includes a transmitting unit 110, a receiving unit 120, a configuring unit 130, and a control unit 140. The functional configuration illustrated in FIG. 9 is just an example. So long as the operation according to the embodiment of the invention can be performed, the function categories and the names of the function units may be freely set.

The transmitting unit 110 includes functions of generating a signal to be transmitted to the terminal 20 side and transmitting the generated signal by radio. In addition, the transmitting unit 110 transmits a message between network nodes to another network node. The receiving unit 120 includes functions of receiving various signals transmitted from the terminal 20 and acquiring information of, for example, a higher layer from the received signal. In addition, the transmitting unit 110 includes a function of transmitting an NR-PSS, an NR-SSS, an NR-PBCH, a DL/UL control signal, and the like to the terminal 20. In addition, the receiving unit 120 receives a message between network nodes from another network node.

The configuring unit 130 stores pre-configured configuration information and various types of configuration information to be transmitted to the terminal 20. Regarding the content of the configuration information, for example, information related to measurement of SINR or RSRP by the terminal 20 is provided.

As described in the example, the control unit 140 performs a control related to the measurement of SINR or RSRP by the terminal 20. The transmitting unit 110 may include the functional unit in the control unit 140, which relates to signal transmission, and the receiving unit 120 may include the functional unit in the control unit 140, which relates to signal reception.

<Terminal 20>

FIG. 10 is a diagram illustrating an example of a functional configuration of the terminal 20 in the embodiment of the invention. As illustrated in FIG. 10, the terminal 20 includes a transmitting unit 210, a receiving unit 220, a configuring unit 230, and a control unit 240. The functional configuration illustrated in FIG. 10 is just an example. So long as the operation according to the embodiment of the invention can be performed, the function categories and the names of the function units may be freely set.

The transmitting unit 210 creates a transmission signal from transmission data and transmits the transmission signal by radio. The receiving unit 220 receives various signals by radio and acquires a signal of a higher layer from the received signal of a physical layer. In addition, the receiving unit 220 includes a function of receiving an NR-PSS, an NR-SSS, an NR-PBCH, a DL/UL/SL control signal, and the like, which are transmitted from the base station 10. In addition, for example, the transmitting unit 210 transmits a PSCCH (Physical Sidelink Control Channel), a PSSCH (Physical Sidelink Shared Channel), a PSDCH (Physical Sidelink Discovery Channel), a PSBCH (Physical Sidelink Broadcast Channel), and the like to another terminal 20 by D2D communication. The receiving unit 220 receives a PSCCH, a PSSCH, a PSDCH, a PSBCH, or the like from another terminal 20.

The configuring unit 230 stores various types of configuration information received from the base station 10 by the receiving unit 220. In addition, the configuring unit 230 also stores pre-configured configuration information. Regarding the content of the configuration information, for example, information related to SINR measurement or RSRP measurement is provided.

As described in the example, the control unit 240 performs a control related to the measurement of SINR or RSRP. The transmitting unit 210 may include the functional unit in the control unit 240, which relates to signal transmission, and the receiving unit 220 may include the functional unit in the control unit 240, which relates to signal reception.

(Hardware Configuration)

The block diagrams (FIGS. 9 and 10) used in the description of the above embodiment illustrate functional unit blocks. The functional blocks (components) are implemented by at least any one combination of hardware and software. In addition, an implementation method of the functional blocks is not particularly limited. That is, each functional block may be implemented by using one device that is physically or logically coupled or may be realized by using a plurality of devices obtained by directly or indirectly (for example, using a wired or wireless manner) connecting two or more devices that are physically or logically separated from each other, with each other. The functional block may be implemented by combining the one device or the plurality of devices with software.

The function includes determining, judging, computing, calculating, processing, deriving, examining, searching, checking, receiving, transmitting, outputting, accessing, solving, selecting, establishing, comparing, assuming, expecting, observing, broadcasting, notifying, communicating, forwarding, configuring, reconfiguring, allocating, mapping, assigning, and the like. The function is not limited to the above description. For example, the functional block (component) for causing transmission is referred to as the transmitting unit or a transmitter. In any case, as described above, the implementation method is not particularly limited.

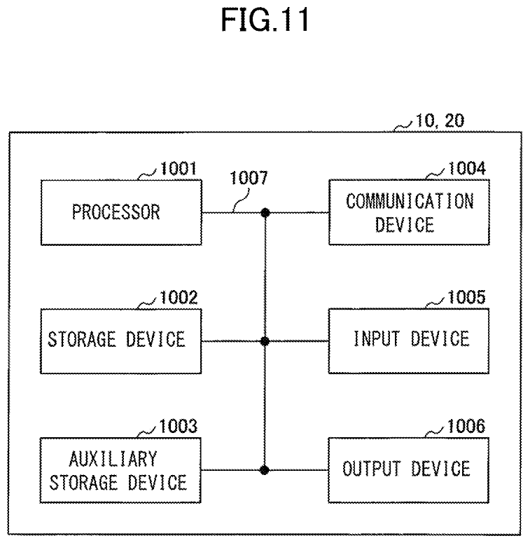

For example, the base station 10, the terminal 20, and the like in one embodiment of the present disclosure may function as a computer that perform the processing of the radio communication method in the present disclosure. FIG. 11 is a diagram illustrating an example of a hardware configuration of the base station 10 and the terminal 20 according to the embodiment of the present disclosure. Each of the base station 10 and the terminal 20 described above may be physically configured as a computer device that includes a processor 1001, a storage device 1002, an auxiliary storage device 1003, a communication device 1004, an input device 1005, an output device 1006, a bus 1007, and the like.

In the following description, the word “device” may be replaced with a circuit, a device, a unit, and the like. The hardware configuration of the base station 10 and the terminal 20 may be configured such that each of the devices illustrated in FIG. 11 may be provided to be one or plural. The hardware configuration may be made without including some devices.

The functions in the base station 10 and the terminal 20 are implemented in a manner that predetermined software (program) is read on hardware such as the processor 1001 and the storage device 1002, and thus the processor 1001 performs an arithmetic operation to control a communication by the communication device 1004 or to control at least one of data reading and data writing in the storage device 1002 and the auxiliary storage device 1003.

The processor 1001 operates, for example, an operating system to control the entirety of the computer. The processor 1001 may be configured by a central processing unit (CPU) including an interface with peripheral equipment, a control device, an arithmetic operation device, a register, and the like. For example, the control unit 140, the control unit 240, and the like described above may be implemented by the processor 1001.

In addition, the processor 1001 reads a program (program codes), a software module, data, and the like from at least one of the auxiliary storage device 1003 and the communication device 1004 into the storage device 1002 and performs various types of processing in accordance with the read program, software module, data, and the like. As such a program, a program causing a computer to perform at least some of the operations described in the above embodiment is used. For example, the control unit 140 in the base station 10 illustrated in FIG. 9 may be implemented by a control program that is stored in the storage device 1002 and operates on the processor 1001. In addition, for example, the control unit 240 in the terminal 20 illustrated in FIG. 10 may be implemented by a control program that is stored in the storage device 1002 and operates on the processor 1001. The description that the above-described various types of processing are performed by one processor 1001 is made. However, the various types of processing may be simultaneously or sequentially performed by two or more processors 1001. The processor 1001 may be mounted by one or more chips. Note that the program may be transmitted from a network via an electrical communication line.

The storage device 1002 is a computer readable recording medium. For example, the storage device 1002 may be configured by at least one of a ROM (Read Only Memory), an EPROM (Erasable Programmable ROM), an EEPROM (Electrically Erasable Programmable ROM), a RAM (Random Access Memory), and the like. The storage device 1002 may be referred to as a register, a cache, a main memory (main storage device), and the like. The storage device 1002 may store a program (program codes), a software module, and the like that are allowed to be executed to perform a radio communication method according to one embodiment of the present disclosure.

The auxiliary storage device 1003 is a computer readable recording medium. For example, the auxiliary storage device 1003 may be configured by at least one of an optical disk such as a CD-ROM (Compact Disc ROM), a hard disk drive, a flexible disk, a magneto-optical disk (for example, compact disk, digital versatile disk, and Blu-ray (registered trademark) disk), a smart card, a flash memory (for example, card, stick, and key drive), a Floppy (registered trademark) disk, a magnetic strip, and the like. The above-described storage medium may be, for example, a database including at least one of the storage device 1002 and the auxiliary storage device 1003, a server, and other appropriate media.

The communication device 1004 is hardware (transmission and reception device) for performing a communication between computers via at least one of a wired network and a wireless network. For example, the communication device 1004 is also referred to as a network device, a network controller, a network card, a communication module, or the like. For example, the communication device 1004 may be configured to include a high frequency switch, a duplexer, a filter, a frequency synthesizer, and the like in order to realize at least one of Frequency Division Duplex (FDD) and Time division Duplex (TDD). For example, a transmission and reception antenna, an amplifying unit, a transmitting and receiving unit, a transmission path interface, and the like may be implemented by the communication device 1004. The transmitting and receiving unit may be made in a manner that the transmitting unit and the receiving unit are physically or logically separated and mounted.

The input device 1005 is an input device (for example, keyboard, mouse, microphone, switch, button, sensor, and the like) that receives an input from the outside. The output device 1006 is an output device (for example, display, speaker, LED lamp, and the like) that performs an output to the outside. Note that the input device 1005 and the output device 1006 have an integrated configuration (for example, touch panel).

The devices such as the processor 1001 and the storage device 1002 are connected to each other by the bus 1007 for performing a communication of information. The bus 1007 may be configured using a single bus or configured using different buses for the devices.

In addition, each of the base station 10 and the terminal 20 may be configured to include hardware such as a microprocessor, a digital signal processor (DSP), an ASIC (Application Specific Integrated Circuit), a PLD (Programmable Logic Device), and an FPGA (Field Programmable Gate Array). With the hardware, some or all of the functional blocks may be implemented. For example, the processor 1001 may be mounted using at least one piece of the hardware.

### Summary of Embodiment

As described above, according to the embodiment of the invention, there is provided the terminal including the control unit that determines the resource to be used for measurement, based on the condition, among a plurality of resources for estimating interference, and the measuring unit that measures L1-SINR (Layer1 Signal to interference plus noise power ratio) using the determined resource.

With the above configuration, the terminal 20 can determine the resource required for measuring the interference, from resource candidates based on the configured condition, and thus can measure L1-SINR by using the determined resource with high efficiency. In addition, in the radio communication system, it is possible to simplify measurement by determining a resource to be used for the measurement from among candidates.

The control unit may perform provisional measurement for determining the condition.

With this configuration, the terminal 20 can determine the resource required for measuring the interference, from resource candidates, according to the provisional measurement prior to the measurement, and can measure L1-SINR by using the determined resource with high efficiency.

The control unit may determine the resource to be used for the measurement, based on measured power, among the plurality of resources. With this configuration, the terminal 20 can determine the resource required for measuring the interference, from resource candidates, according to the provisional measurement prior to the measurement, and can measure L1-SINR by using the determined resource with high efficiency.

The control unit may determine the resource in which maximum interference power has been measured among the plurality of resources, to be the resource to be used for the measurement. With this configuration, the terminal 20 can determine the resource that receives the strongest interference, from resource candidates, according to the provisional measurement prior to the measurement, and can measure L1-SINR by using the determined resource with high efficiency.

When measured interference power of a given resource is equal to or less than interference power that is less than a maximum interference power of a resource by a predetermined value, the control unit need not use, among the plurality of resources, the given resource for the measurement. With this configuration, the terminal 20 can exclude the resource that receives the relatively weak interference, from resource candidates, according to the provisional measurement prior to the measurement, and can measure L1-SINR by using the remaining resources with high efficiency.

In addition, according to the embodiment of the invention, there is provided a measuring method including, by the terminal, a control procedure of determining a resource to be used for measurement, based on a condition, among a plurality of resources for estimating interference, and a measurement procedure of measuring L1-SINR (Layer1 Signal to interference plus noise power ratio) using the determined resource.

With the above configuration, the terminal 20 can determine the resource required for measuring the interference, from resource candidates based on the configured condition, and thus can measure L1-SINR by using the determined resource with high efficiency. In addition, in the radio communication system, it is possible to simplify measurement by determining a resource to be used for the measurement from among candidates.

### Supplement of Embodiment

Hitherto, the embodiment of the invention is described, but the disclosed invention is not limited to such an embodiment, and those skilled in the art will understand various variations, modifications, alternatives, and substitutions. Although the description is made using specific numerical values for facilitating the understanding of the invention, unless otherwise specified, those numerical values are merely examples and any appropriate values may be used. The division of items in the above description is not essential to the present invention, contents described in two or more items may be used in combination as necessary, and contents described in one item may be applied to the contents described in another item (so long as there is no contradiction). The boundaries of the functional units or the processing units in the functional block diagram do not normally correspond to the boundaries of physical components. The operations of a plurality of functional units may be physically performed by one component, or the operation of one functional unit may be physically performed by the plurality of components. Regarding the processing procedure described in the embodiment, the order of the processing may be changed so long as there is no contradiction. Although the base station 10 and the terminal 20 have been described using the functional block diagrams for convenience of description of the processing, such a device may be implemented in hardware, software, or a combination thereof. Each piece of the software that operates by the processor in the base station 10 according to the embodiment of the invention and the software that operates by the processor in the terminal 20 according to the embodiment of the invention may be stored in a random access memory (RAN), a flash memory, a read only memory (ROM), an EPROM, an EEPROM, a register, a hard disk drive (HDD), a removable disk, a CD-ROM, a database, a server, and any other appropriate storage media.

In addition, the indication of information is not limited to the aspect/embodiment described in the present disclosure, and may be performed using another method. For example, the indication of information may be performed by physical layer signaling (for example, DCI (Downlink Control Information) and UCI (Uplink Control Information)), higher layer signaling (for example, RRC (Radio Resource Control) signaling, MAC (Medium Access Control) signaling, broadcast information (MIB (Master Information Block) and SIB (System Information Block))), other signals, or a combination thereof. In addition, the RRC signaling may be referred to as an RRC message, and may be, for example, an RRC Connection Setup message, an RRC Connection Reconfiguration message, and the like.

The aspect/embodiment described in the present disclosure may be applied to at least one of systems using LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and the next generation system expanded based on the above systems. The embodiment may be applied to a combination (for example, combination of 5G and at least one of LTE and LTE-A, and the like) of a plurality of systems.

The order in the processing procedure, the sequence, the flowchart, and the like in the aspect/embodiment described in the present specification may be changed so long as there is no contradiction. For example, regarding the method described in the present disclosure, various step elements are presented using an order example, and the method is not limited to the presented specific order.

The specific operation set to be performed by the base station 10 in the present specification may be performed by an upper node in some cases. In a network configured by one or a plurality of network nodes including the base station 10, it is clear that various operations performed for a communication with the terminal 20 may be performed by at least one of the base station 10 and network nodes (for example, MME, S-GW, and the like are considered, but the network node is not limited thereto) other than the base station 10. A case where one network node other than the base station 10 is provided is described above as an example. However, a combination (for example, MME and S-GW) of a plurality of other network nodes may be provided as the other network node.

The information, the signal, and the like described in the present disclosure may be output from a higher layer (or lower layer) to the lower layer (or higher layer). The information, the signal, and the like may be input or output through a plurality of network nodes.

Information and the like to be input and output may be stored in a specific place (for example, memory) and may be managed using a management table. The information and the like to be input and output may be overwritten, updated, or added. The output information and the like may be deleted. The input information and the like may be transmitted to another device.

Determination in the present disclosure may be performed by a value (0 or 1) expressed by one bit, may be performed by a Boolean value (true or false), or may be performed by comparison of a numerical value (for example, comparison to a predetermined value).

Regardless of whether the software is referred to as software, firmware, middleware, the microcode, the hardware description language, or any other name, the software is required to be broadly construed to mean an instruction, an instruction set, a code, a code segment, a program code, a program, a subprogram, a software module, an application, a software application, a software package, a routine, a subroutine, an object, an executable file, an execution thread, a procedure, a function, and the like.

In addition, the software, the instruction, the information, and the like may also be transmitted and received through a transmission medium. For example, when the software is transmitted from a web site, a server, or other remote sources by using at least one of a wired technology (coaxial cable, optical fiber cable, twisted pair, digital subscriber line (DSL), and the like) and a wireless technology (infrared rays, microwaves, and the like), at least one of the wired technology and the wireless technology is included in the definition of the transmission medium.

The information, the signal, and the like described in the present disclosure may be represented using any of various different technologies. For example, data, an instruction, a command, information, a signal, a bit, a symbol, a chip, and the like may be represented by a voltage, a current, an electromagnetic wave, a magnetic field or magnetic particle, an optical field or photon, or any combination thereof.

Note that the terms described in the present disclosure and the terms necessary for understanding the present disclosure may be replaced with terms having the same or similar meanings. For example, at least one of the channel and the symbol may be a signal (signaling). In addition, the signal may also be a message. In addition, a component carrier (CC) may be referred to as a carrier frequency, a cell, a frequency carrier, or the like.

The terms “system” and “network” used in the present disclosure are used interchangeably.

Further, the information, the parameters, and the like described in the present disclosure may be represented by using an absolute value, may be represented by using a relative value from a predetermined value, or by using other corresponding information. For example, a radio resource may be instructed by an index.

The names used for the above parameters are not limited in any point. Further, expressions and the like using the parameters may differ from the expressions that are explicitly disclosed in the present disclosure. Since various channels (for example, PUCCH, PDCCH, and the like) and information elements can be identified by any suitable names, various names allocated to the various channels and information elements are not limited in any point.

In the present disclosure, the terms such as “base station (BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, and “component carrier” may be used interchangeably. The base station may be referred to as terms such as a macro cell, a small cell, a femto cell, and a pico cell.

The base station may accommodate one or a plurality (for example, three) of cells. When the base station accommodates the plurality of cells, the entirety of a coverage area of the base station may be divided into a plurality of smaller areas. A communication service may be provided in each of the smaller areas may provide by a base station subsystem (for example, small indoor base station (RRH: Remote Radio Head). The term “cell” or “sector” refers to a portion or the entirety of a coverage area of at least one of the base station and the base station subsystem that performs a communication service in this coverage.

In the present disclosure, the terms such as “mobile station (MS)”, “user terminal”, “user equipment (UE)”, and “terminal” may be used interchangeably.

The mobile station may be referred, by those skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or any other appropriate term.

At least one of the base station and the mobile station may be referred to as a transmission device, a reception device, a terminal, or the like. Note that at least one of the base station and the mobile station may be a device mounted in a moving object or be a moving object itself. The moving object may be a vehicle (for example, car, airplane, and the like), a moving object (for example, drone, self-driving car, and the like) that moves in an unmanned manner, or a robot (manned or unmanned type). Note that at least one of the base station and the mobile station includes a device that needs not to move in a communication operation. For example, at least one of the base station and the mobile station may be an IoT (Internet of Things) device such as a sensor.

In addition, the base station in the present disclosure may be replaced with a user terminal. For example, the aspect/embodiment of the present disclosure may be applied to a configuration in which a communication between the base station and the user terminal is replaced with a communication (may be referred to as D2D (Device-to-Device) or V2X (Vehicle-to-Everything), for example) between a plurality of terminals 20. In this case, a configuration in which the function of the above-described base station 10 is provided in the terminal 20 may be made. In addition, the words such as “up” and “down” may be replaced with words (for example, “side”) corresponding to a communication between terminals. For example, an uplink channel, a downlink channel, and the like may be replaced with a side channel.

Similarly, the user terminal in the present disclosure may be replaced with the base station. In this case, a configuration in which the function of the above-described user terminal is provided in the base station 10 may be made.

The term “determining” used in the present disclosure may encompass a wide variety of operations. “Determining” may include, for example, a case where judging, calculating, computing, processing, deriving, investigating, looking up, search, inquiry (for example, searching in a table, a database, or another data structure) are considered as “determining”. In addition, “determining” may include, for example, a case where receiving (for example, receiving information), transmitting (for example, transmitting information), input, output, accessing (for example, accessing data in a memory) are considered as “determining”, and the like. In addition, “determining” may include a case where resolving, selecting, choosing, establishing, comparing, and the like are considered as “determining”. That is, “determining” may include the case of considering a certain operation as “determining”. In addition, “determining” may be replaced with “assuming”, “expecting”, “considering”, and the like.

The terms “connected” and “coupled”, or any variation thereof mean any direct or indirect connection or coupling between two or more elements, and may include a case where one or more intermediate elements are provided between the two elements “connected” or “coupled” to each other. The connection or coupling between elements may be physically performed, be logically performed, or be performed in a combination thereof. For example, the “connection” may be replaced with an “access”. When the term is used in the present disclosure, it may be considered that two elements are “connected” or “coupled” to each other by using at least one of one or more electrical wires, cables and printed electrical connections, and by using electromagnetic energy having wavelengths in a radio frequency range, a microwave range, and an optical (both visible and invisible) range, as some non-limiting and non-inclusive examples.

The reference signal may be abbreviated as RS and may be referred to as a pilot in accordance with the applied standard.

The phrase “based on” used in the present disclosure does not mean “based on only” so long as particular statement is not made. In other words, the phrase “based on” means both “based on only” and “based on at least”.

Any reference to elements using the designations of “first”, “second”, and the like used in the present disclosure does not generally limit the amount or order of the elements. The designations may be used in present disclosure as a convenient manner to distinguish between two or more elements. Thus, references to the first and second elements do not mean that only two elements may be employed, or that the first element must precede the second element in any form.

“Means” in the configuration of the above devices may be replaced with “unit”, “circuit”, “device”, and the like.

In the present disclosure, when the terms “include”, “including”, and variations thereof are used, the terms are intended to be inclusive, as with the term “comprising”. Further, the term “or” used in the present disclosure is intended not to be exclusive-OR.

A radio frame may be configured by one or a plurality of frames in time domain. One or each of a plurality of frames in the time domain may be referred to as a subframe. The subframe may be further configured by one or a plurality of slots in the time domain. The subframe may have a fixed time length (for example, 1 ms) that does not depend on numerology.

The numerology may be a communication parameter to be applied to at least one of transmission and reception of a certain signal or channel. The numerology may indicate at least one of, for example, subcarrier spacing (SCS), a bandwidth, a symbol length, a cyclic prefix length, a transmission time interval (TTI) length, the number of symbols per TTI, a radio frame configuration, specific filtering processing performed by a transmission and reception device in the frequency domain, specific windowing processing performed by the transmission and reception device in the time domain, and the like.

The slot may be configured by one or a plurality of symbols (OFDM (Orthogonal Frequency Division Multiplexing) symbol, SC-FDMA (Single Carrier Frequency Division Multiple Access) symbol, and the like) in the time domain. The slot may be a time unit based on the numerology.

The slot may include a plurality of mini slots. Each mini slot may be configured by one or a plurality of symbols in the time domain. In addition, the mini slot may also be referred to as a subslot. The mini slot may be configured by a smaller number of symbols than the number of slots. A PDSCH (or PUSCH) to be transmitted in a time unit larger than the mini slot may be referred to as a PDSCH (or PUSCH) mapping type A. A PDSCH (or PUSCH) to be transmitted using a mini slot may be referred to as a PDSCH (or PUSCH) mapping type B.

All of the radio frame, the subframe, the slot, the mini slot, and the symbol indicate a time unit when a signal is transmitted. Other names corresponding to the radio frame, the subframe, the slot, the mini slot, and the symbol may be used.

For example, one subframe may be referred to as a transmission time interval (TTI). A plurality of continuous subframes may be referred to as the TTI. One slot or one mini slot may be referred to as the TTI. That is, at least one of the subframe and the TTI may be a subframe (1 ms) in the known LTE, be a period (for example, 1 to 13 symbols) shorter than 1 ms, or be a period longer than 1 ms. Note that the unit representing the TTI may be referred to as not the subframe, but a slot, a mini slot, or the like.

Here, the TTI refers to a minimum time unit for scheduling in a radio communication, for example. For example, in an LTE system, the base station performs scheduling in which radio resources (frequency bandwidth, transmission power, and the like used in each terminal 20) are allocated in a TTI unit, for each terminal 20. Note that the definition of the TTI is not limited to the above description.

The TTI may be a transmission time unit of a channel-coded data packet (transport block), a code block, a codeword, or the like, or may be a processing unit of scheduling, link adaptation, or the like. Note that, when the TTI is given, a time interval (for example, the number of symbols) in which a transport block, a code block, a codeword, or the like is mapped in practice may be shorter than the TTI.

Note that, when one slot or one mini slot is referred to as the TTI, one or more TTIs (that is, one or more slots, or one or more mini slots) may be the minimum time unit for scheduling. In addition, the number of slots (the number of mini slots) forming the minimum time unit for the scheduling may be controlled.

The TTI having a time length of 1 ms may be referred to as a general TTI (TTI in LTE Rel.8-12), a normal TTI, a long TTI, a general subframe, a normal subframe, a long subframe, a slot, and the like. A TTI shorter than the general TTI may be referred to as a reduced TTI, a short TTI, a partial TTI (or fractional TTI), a reduced subframe, a short subframe, a mini slot, a subslot, a slot, and the like.

Note that the long TTI (for example, general TTI, subframe, and the like) may be replaced with a TTI having a time length which is longer than 1 ms. The short TTI (for example, reduced TTI and the like) may be replaced with a TTI having a TTI which is shorter than the TTI length of a long TTI and is equal to or longer than 1 ms.

A resource block (RB) is a resource allocation unit in the time domain and the frequency domain. The resource block may include one or a plurality of continuous subcarriers in the frequency domain. The number of subcarriers included in an RB may be equal regardless of the numerology and may be 12, for example. The number of subcarriers included in an RB may be determined based on the numerology.

In addition, an RB in the time domain may include one or a plurality of symbols, and the RB may have a length of one slot, one mini slot, one subframe, or one TTI. One TTI, one subframe, or the like may be configured by one or a plurality of resource blocks.

Note that one or a plurality of RBs may be referred to as a physical resource block (PRB), a subcarrier group (SCG), a resource element group (REG), a PRB pair, an RB pair, or the like.

In addition, the resource block may also be configured by one or a plurality of resource elements (RE). For example, one RE may be a radio resource area of one subcarrier and one symbol.

A bandwidth part (BWP) (may be referred to as a partial bandwidth or the like) may represent a subset of continuous common RBs (resource blocks) for a certain numerology in a certain carrier. Here, the common RB may be specified by the index of the RB based on the common reference point of the carrier. The PRB may be defined in a BWP and is numbered within that BWP.

The BWP may include a BWP (UL BWP) for an UL and a BWP (DL BWP) for a DL. One or a plurality of BWPs may be configured in one carrier for a UE.

At least one of configured BWPs may be active. The UE need not assume transmission and reception of a predetermined signal/channel in parts other than the active BWP. Note that the “cell”, the “carrier”, and the like in the present disclosure may be replaced with the “BWP”.

The above-described structures of the radio frame, the subframe, the slot, the mini slot, the symbol, and the like are just an example. For example, the configuration such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, a symbol length, and a cyclic prefix (CP) length may be variously changed.

In the present disclosure, for example, when translations add articles such as a, an, and the in English, the present disclosure may include the nouns that follow the articles in the plural.

In the present disclosure, the phrase “A and B are different” may mean that “A and B are different from each other”. Note that the phrase may mean that “A and B are different from C”. The terms “separate”, “coupled”, and the like may be construed as the similar meaning to “being different”.

The aspect/embodiment described in the present disclosure may be singly used, be used in combination thereof, or be used by being switched with performing. In addition, an indication of predetermined information (for example, indication of “being X”) is not limited to being explicitly performed and may be implicitly performed (for example, the indication of the predetermined information is not performed).

Note that, in the present disclosure, the receiving unit 220 is an example of the measuring unit.

Although the present disclosure has been described in detail above, it will be apparent to those skilled in the art that the invention is not limited to the embodiment described in the present specification. The present disclosure can be implemented as modifications and changes without departing from the spirit and scope of the present disclosure defined by the description of the claims. Therefore, the description of the present disclosure is for the purpose of exemplifying explanation, and does not have any restrictive meaning to the present disclosure.

### EXPLANATIONS OF LETTERS OR NUMERALS

10 BASE STATION
110 TRANSMITTING UNIT
120 RECEIVING UNIT
130 CONFIGURING UNIT
140 CONTROL UNIT
20 TERMINAL
210 TRANSMITTING UNIT
220 RECEIVING UNIT
230 CONFIGURING UNIT
240 CONTROL UNIT
1001 PROCESSOR
1002 STORAGE DEVICE
1003 AUXILIARY STORAGE DEVICE
1004 COMMUNICATION DEVICE
1005 INPUT DEVICE
1006 OUTPUT DEVICE

1. A terminal comprising:
a control unit that determines a resource to be used for measurement, based on a condition, among a plurality of resources for estimating interference; and
a measuring unit that measures L1-SINR (Layer1 Signal to interference plus noise power ratio) using the determined resource.

2. The terminal according to claim 1,
wherein the control unit performs provisional measurement for determining the condition.

3. The terminal according to claim 2,
wherein the control unit determines the resource to be used for the measurement, based on measured power, among the plurality of resources.

4. The terminal according to claim 3,
wherein the control unit determines a resource in which maximum interference power has been measured among the plurality of resources, to be the resource to be used for the measurement.

5. The terminal according to claim 3,
wherein, when measured interference power of a given resource is equal to or less than interference power that is less than a maximum interference power of a resource by a predetermined value, the control unit refrains from using, among the plurality of resources, the given resource for the measurement.

6. A measuring method comprising:
by a terminal,
a control procedure of determining a resource to be used for measurement, based on a condition, among a plurality of resources for estimating interference; and
a measurement procedure of measuring L1-SINR (Layer1 Signal to interference plus noise power ratio) using the determined resource.
